(19) United States
(12) Patent Application Publication
(10) Pub. No.: US 2025/0156780 A1
(43) Pub. Date: May 15, 2025

(54) SYSTEM AND METHOD FOR IMPLEMENTING A GENERATIVE AI RAPID ASSESSMENT TOOL

(71) Applicant: KPMG LLP, New York, NY (US)

(72) Inventors: Sanjay Sehgal, Potomac, MD (US); Htike Htike Kyaw Soe, Great Neck, NY (US); John A. Pacilio, Camillus, NY (US)

(21) Appl. No.: 18/946,394

(22) Filed: Nov. 13, 2024

Related U.S. Application Data
(60) Provisional application No. 63/598,417, filed on Nov. 13, 2023.

(51) Int. Cl. G06Q 10/0631

(52) U.S. Cl. CPC G06Q 10/06313; G06Q 10/063118

(57) ABSTRACT

An embodiment of the present invention is directed to a Generative AI Rapid Assessment Tool that provides core analytic outcomes relating to value; focus, readiness and urgency. An embodiment of the present invention aims to assess company-specific Gen AI opportunity. This is curated using industry and function-oriented Gen AI use-cases, industry impact expectations, and company-insights, derived by analysis third-party data to calculate potential value. An embodiment of the present invention then narrows the field of opportunity value. Analysis is completed at the function, sub-function and use-case/activity levels to suggest where there may be the greatest area of opportunity. This helps mitigate the need to focus attention and resources throughout the entire business, and address identified priority areas.

### CROSS-REFERENCE TO RELATED APPLICATIONS

The application claims priority to U.S. Provisional Application No. 63/598,417 (Attorney Docket No. 055089.0000121), filed Nov. 13, 2023, the contents of which are incorporated by reference herein in their entirety.

### FIELD OF THE INVENTION

The present invention relates to systems and methods for workforce and technology assessment and more specifically to implementing a Generative AI rapid assessment tool to generate a Generative AI strategy to facilitate and optimize integration.

### BACKGROUND

Generative AI generally refers to models and algorithms that create new output from vast amounts of training data. Companies are seeking ways to integrate Generative AI for a wide range of services to improve team efficiency, accuracy and effectiveness. While the potential is vast, it takes significant effort and data to identify an integration path forward. Solutions that may be applicable to one entity may not be a good fit for another entity in a different industry or field. In addition, companies of varying sizes and resources will have different Generative AI opportunities.

It would be desirable, therefore, to have a system and method that could overcome the foregoing disadvantages of known systems.

### SUMMARY

According to an embodiment, the invention relates to a computer-implemented system that implements a Generative AI Opportunity Assessment Tool. The system comprises: an input configured to access one or more data sources that store and manage workforce data for at least one target entity; an interactive user interface that communicates with one or more user devices via a communication network; and a computer processor coupled to the input, the interactive user interface and the one or more data sources, the computer processor further configured to: identify a target entity and a set of peer entities; generate a baseline assessment, by applying an assessment model, of a financial opportunity for the target entity in leveraging Generative AI at scale; align organization role profiles of the target entity with a taxonomy that classifies work activities and processes; applying a unique set of use cases, identify a set of organizational roles that illustrate Generative AI agents of change; generate a productivity estimate at an activity level based on workforce data relevant to the target entity; determine an impact comprising a number of workers and total salaries; generate a Generative AI driven workforce capacity value defined by role and function and supplemented with relevant use-cases; generate a current state assessment of existing technology and skills within the target entity relating to Generative AI wherein the current state assessment is based on third party workforce salary and skills data at a role level; apply the assessment model to the target entity's workforce data to determine an appropriate change management relating to technology and workforce shaping; and identify a workforce capacity opportunity for the target entity.

According to another embodiment, the invention relates to a computer-implemented method that implements a Generative AI rapid assessment tool. The method comprises the steps of: identifying a target entity and a set of peer entities; generating a baseline assessment, by applying an assessment model, of a financial opportunity for the target entity in leveraging Generative AI at scale; aligning organization role profiles of the target entity with a taxonomy that classifies work activities and processes; applying a unique set of use cases, identifying a set of organizational roles that illustrate Generative AI agents of change; generating a productivity estimate at an activity level based on workforce data relevant to the target entity; determining an impact comprising a number of workers and total salaries; generating a Generative AI driven workforce capacity value defined by role and function and supplemented with relevant use-cases; generating a current state assessment of existing technology and skills within the target entity relating to Generative AI wherein the current state assessment is based on third party workforce salary and skills data at a role level; applying the assessment model to the target entity's workforce data to determine an appropriate change management relating to technology and workforce shaping; and identifying a workforce capacity opportunity for the target entity.

According to another embodiment, the invention also relates to a computer-readable medium containing program instructions for executing a method for implementing a Generative AI rapid assessment tool.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flowchart, according to an embodiment of the present invention.

FIG. 2 is an exemplary illustration of a conceptual model, according to an embodiment of the present invention.

FIG. 3 is an exemplary user interface, according to an embodiment of the present invention.

FIG. 4 is an exemplary user interface, according to an embodiment of the present invention.

FIG. 5 is an exemplary user interface, according to an embodiment of the present invention.

FIG. 6 is an exemplary user interface, according to an embodiment of the present invention.

FIG. 7 is an exemplary diagram, according to an embodiment of the present invention.

FIG. 8 is an exemplary user interface, according to an embodiment of the present invention.

FIG. 9 is an exemplary user interface, according to an embodiment of the present invention.

FIG. 10 is an exemplary user interface, according to an embodiment of the present invention.

FIG. 11 is an exemplary user interface, according to an embodiment of the present invention.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

An embodiment of the present invention is directed to a Generative AI Rapid Assessment Tool that provides core analytic outcomes relating to value, focus, readiness and urgency.

An embodiment of the present invention aims to assess company-specific Generative AI (“Gen AI”) Opportunities. A Gen AI value or opportunity may represent an estimated opportunity based on an assumed percentage of impact to work done from Gen AI implementations. Gen AI Opportunities may be curated using industry and function-oriented Gen AI use-cases, company and/or industry impact expectations, and company-insights, derived by analysis of third-party data to calculate potential value.

An embodiment of the present invention may then narrow the field of opportunity value. Analysis may be completed at the function, sub-function and/or use-case/activity levels to suggest where there may be the greatest area of opportunity. This helps mitigate the need to focus attention and resources throughout the entire business, and address identified priority areas.

An embodiment of the present invention is directed to providing an organization with a recommendation on investment expectations from capturing Gen AI benefits. This may be estimated by calculating the required dollar amount (or other resource) through analysis of the organization by benchmarking current investments in people and technology. Findings may provide insight into what activities may be required to further unlock the full value of Gen AI.

Peer benchmarking of Generative AI opportunity value may highlight the potential benefits of Gen AI investments and potential disruption for those who choose to implement a Gen AI strategy. An organization may compare their current investments in people and technology to peers, calculate the required investment, and define what is needed to unlock the full value of Gen AI.

For example, a Gen AI Rapid Assessment analytic methodology may be conducted using third-party data and modeling techniques. The data contained in the analysis may be directional information about a given organization curated from third-party data sources and analyzed using proprietary techniques and Gen AI use-cases.

The Gen AI Rapid Assessment analytic methodology may be used as a starting point for discussion. For example, data and analysis contained may be meant to be directional and illustrative with the expectation that a Phase 0 assessment is conducted thereafter using the organization's own data and perspectives.

An embodiment of the present invention is directed to quantifying various opportunities for a target entity as compared to peer entities with respect to Generative AI technology. An embodiment of the present invention is also directed to assessing a target entity's current state and resources. For example, an embodiment of the present invention may determine a target company's resources in terms of people, skillsets and technology. This may also include determining a state of readiness for Gen AI adoption. An embodiment of the present invention may be applied to a target company to determine whether current resources (e.g., people, technology) may be leveraged and what additional investments should be made.

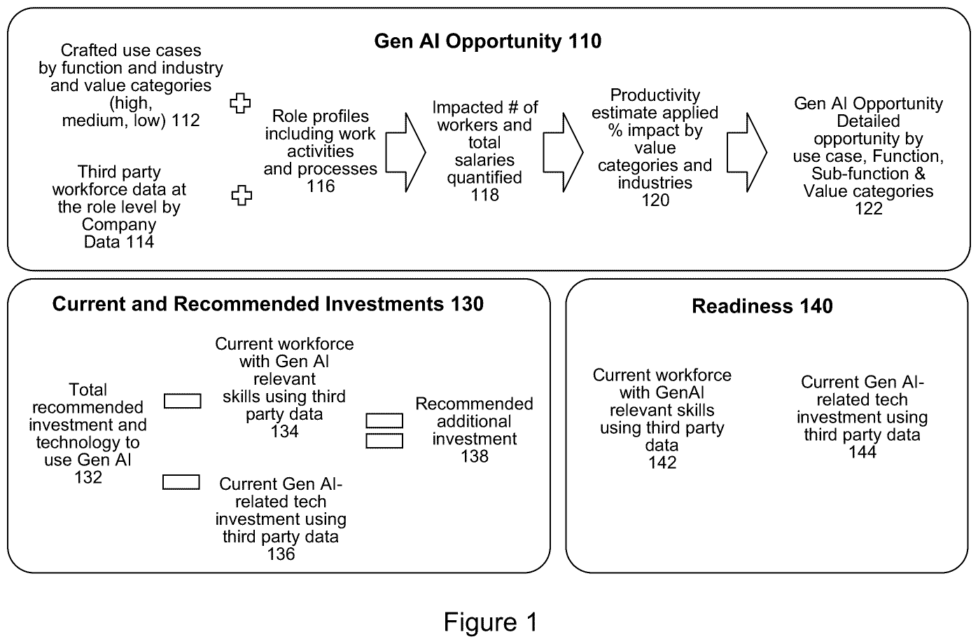

FIG. 1 is an exemplary flowchart, according to an embodiment of the present invention. FIG. 1 illustrates Gen AI Opportunity 110, Current and Recommended Investments 130 and Readiness 140.

As shown by Gen AI Opportunity 110, inputs may include crafted use cases by function and industry and value categories (e.g., high, medium, low), as shown by 112, and Third party workforce data at the role level by company, as shown by 114. Use cases may represent possible applications of Gen AI across organizations. These inputs may be mapped to role profiles identified by a taxonomy, as shown by 116. This may include work activities and processes. Third party data may include a range of sources including ONET (occupational information network), WEF (world economic forum) and other databases, in addition to internal taxonomies to understand the typical activities and processes by role and how those may be impacted by Gen AI. The mapped data may be used to determine an impact. Impact may represent impacted number of workers and total salaries/compensation quantified, as shown by 118. Other metrics may be identified. A Productivity estimate may be applied, at 120. This may represent a percentage impacted by value categories and industries. An embodiment of the present invention may identify Gen AI opportunities which may include a detailed opportunity by use case, function, sub-function and/or value categories, as shown by 122.

An embodiment of the present invention may apply a set of propriety use cases specific to Generative AI (e.g., by industry, by function, by process, etc.) to a taxonomy. For example, a set of 600+ proprietary uses cases around Gen AI may be organized by industry, function and/or processes. An embodiment of the present invention may leverage various sources of data including third party data to quantify impact.

Third party data (e.g., employment focused social media platform, employment/recruiting platforms, etc.) may be used to identify a target company's employees, roles, salary, job openings, etc. This information may then be used to determine specific metrics and information including types of roles, number of employees, etc. The use cases may be leveraged to understand what those roles mean, e.g., how they function, how they operate, etc.

Role profiles may be identified through a taxonomy or other classification that identifies how an organization functions. Details may include types of roles, responsibilities, qualifications, etc. These details may connect with use cases to reveal what people do and how the use cases impact the business. An embodiment of the present invention recognizes that each organization has different roles depending on business model, industry, sector, etc. This information may be used to make estimates and determine an impact (e.g., percentage, etc.) on an employee's time.

For example, use cases may vary depending on industries. An automobile maker will have different inputs from a pharmaceutical company. Other differences may include number of people, different pay, different work, tasks, business objectives, etc.

An exemplary use case may involve bookkeeping or other finance related task. The bookkeeping use case may have a human to machine coefficient of 30% (e.g., 30% machine, 70% people). A target entity may have 15 employees who perform this bookkeeping task. With a 30% coefficient, this may result in 5 employees. With an average salary or $100 K for each employee, an embodiment of the present invention may determine a $500 K opportunity or 30% time saved. These use cases may be applied to quantify and/or determine how Gen AI may be applied to a target company. Gen AI opportunity may also be provided as a range, e.g., low, mid and high complexity opportunities.

As shown by Current and Recommended Investments 130, total recommended investment and/or identifying technology that may be necessary for that specific company to use Gen AI, as shown by 132. According to an example, total recommended investment may correspond to a percentage of non-COGS data. Other variations may be applied. This may be compared to current workforce with Gen AI relevant skills using third party data, as shown by 134, and current Gen AI related technology investment third party data, as shown by 136. According to an example, the combination of these insights may be used to recommend additional investments, as shown by 138. According to another embodiment, actual target company data may be used with or instead of third party data.

Readiness 140 may include: current workforce with Gen AI relevant skills using third party data (as shown by 142); current Gen AI-related technology investment using third party data (as shown by 144). According to another embodiment, actual target company data may be used with or instead of third party data. This may also apply to the estimation of the Gen AI opportunity.

An embodiment of the present invention may be directed to determining: Investment in Gen AI related People and Technology as well as Opportunities to leverage Gen AI.

A Gen AI Rapid Assessment Framework may include: Total Gen AI Value; Existing Investments in Gen AI-aligned Technology and People; Recommended Gen AI-Focused Investments; Core Analytic Outcomes and Unlocked Gen AI-driven business value.

Total Gen AI Value relates to financial quantification of potential future opportunities (e.g., growth and productivity measures) associated with Gen AI-impacted knowledge workers. Growth may refer to opportunities associated with roles that may drive revenue growth through more efficient sales and product improvement opportunities, etc. using Gen AI. In addition, outcome based data may be used to better estimate potential growth opportunities. Productivity may refer to opportunities for the organization that improves efficiency through automation or workforce streamlining through Gen AI.

Existing Investments in Gen AI-aligned Technology and People may relate to assessment and benchmarking of target and peer Gen AI-aligned technologies and skilled workers present within the organization, inclusive of secondary peer benchmarking.

Recommended Gen AI-Focused Investments may be driven by industry best in class investment thresholds where a rapid assessment model quantifies the required outlay an organization must allocate to capture the total Gen AI opportunity and/or identifying technology that may be necessary for that specific company to use Gen AI.

Core Analytic Outcomes may capture Value and Readiness. Value may move beyond traditional benchmarks to assess company-specific Gen AI opportunity. This may be curated using industry and function-oriented Gen AI use-cases, industry impact expectations, and company-examining third-party data to create a true picture of value. Readiness provides the organization a recommendation on investment expectations to capture Gen AI benefits by calculating the required dollar amount, and analyzing the organization by exploring current investments in people and technology (surrounded by extensive peer benchmarking), ultimately defining what is required to unlock the full value of Gen AI.

Unlocked Gen AI-driven business value may calculate resulting value from a Gen AI opportunity to achieve maximum Gen AI impact on the business. Detailed Gen AI opportunity may be captured at functional and department levels allowing for prioritization of activities with the greatest potential impact

An embodiment of the present invention may be directed to Peer Selection through key metrics. Key metrics may include total employees, total revenue, total non-COGS operating expense, total forecasted technology spend and total technology applications.

An embodiment of the present invention is directed Gen AI rapid value assessment and implementing a Gen AI rapid workforce capacity assessment methodology.

According to an embodiment of the present invention, a multi-stage approach supports clients in their journey to cultivate quantifiable benefit from Gen AI for their workforce.

At a first stage, an embodiment of the present invention generates Gen AI rapid insights by implementing a directional and outside-in model that provides a baseline assessment of the financial opportunity an organization could capture should they begin leveraging Gen AI at scale and a current state assessment of existing technologies and skills within the organization foundational or adjacent to Gen AI.

At a second stage, an embodiment of the present invention guides the client through a more precise and inside-out process that includes running the same model using the client's own workforce data and management interviews on critical priorities to determine an appropriate change management (e.g., technology and workforce shaping) to generate value.

Accordingly, organizations may accurately identify which functions have the greatest opportunity as a place to start, and then assess their current state of technology and skills.

After both stages, clients will have a clear roadmap on how and where to provided resources aimed at generating value from Gen AI.

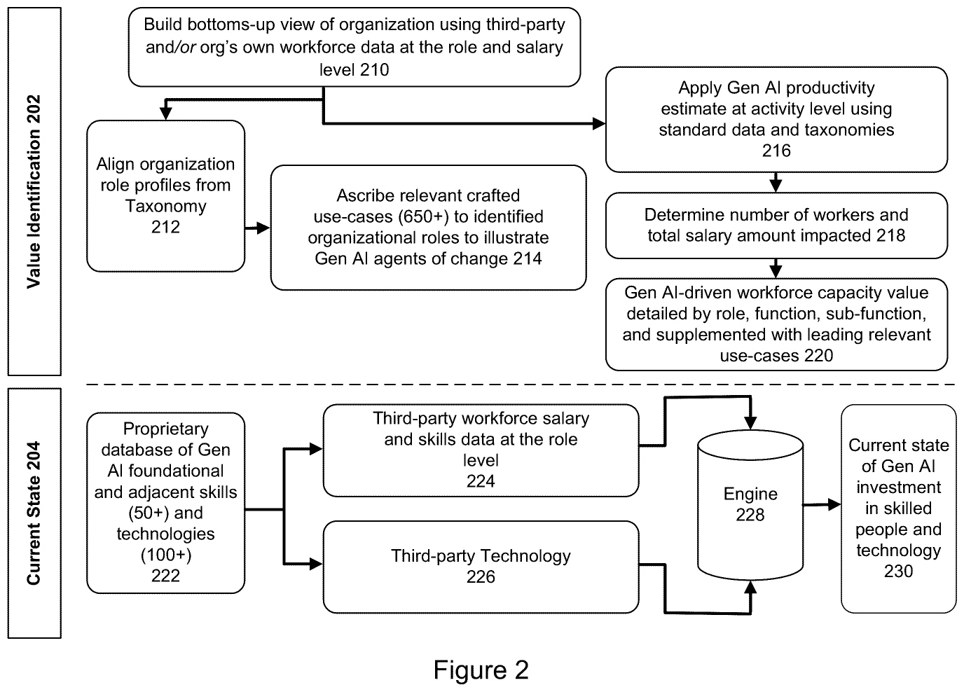

FIG. 2 is an exemplary illustration of a conceptual model, according to an embodiment of the present invention. Value Identification 202 may involve steps to assess workforce capacity value. Current State 204 provides an assessment of current Gen AI investment.

Value Identification 202 may involve building a view of an organization. At step 210, third party data or an organization's own workforce data at the role and salary level may be used to build a bottoms-up view of the organization. Workforce data may be obtained from various sources including professional networks, workforce platform that provides information on companies, salaries, job openings, etc. At step 212, organization role profiles from an internal taxonomy may be aligned. At step 214, use cases may be ascribed to identified organizational roles to illustrate Gen AI agents of change. At step 216, a Gen AI productivity estimate may be applied at the activity level using standard data and taxonomies from various sources. At step 218, a number of workers and total salary amount impacted may be determined. At step 220, Gen AI-drive workforce capacity value detailed by role, function, sub-function and/or other factors may be identified and further supplemented with leading relevant use-cases.

At step 222, a proprietary database of Gen AI foundational and adjacent skills and technologies may be accessed. At step 224, third party workforce salary and skills data at the role level may be identified. At step 226, third party technology data may be identified. Third party technology data may be based on various insights from vendor contracts, bill of sale data, etc. For example, the insights may represent third party technology data based on data vendors that provide information around the applications that are likely to exist at a company. Data may be aggregated at Engine 228 which may then be used to identify current state of Gen AI investment in skilled people and technology at 230. Engine 228 may identify skills, roles and technology that accelerate the Gen AI adoption journey.

An embodiment of the present invention may offer significant opportunities for various entities in a wide range of industries. Gen AI Industry trends may be identified including workforce capacity quantified opportunities, opportunity hosted functions, impacted workforce and talent identification. Illustrative industry oriented use cases may include: inventory management, supply chain optimization, predictive maintenance and scheduling.

For example, an embodiment of the present invention may generate algorithms and models to optimize inventory management, considering factors such as demand variability, lead times, holding costs, and service level targets. In addition, an embodiment of the present invention may generate optimization models for end-to-end supply chain optimization, considering factors such as cost, service levels, capacity, constraints and regulatory requirements. Further, an embodiment of the present invention may generate predictive models to identify potential hardware failures and proactively schedule maintenance for assets based on historical data

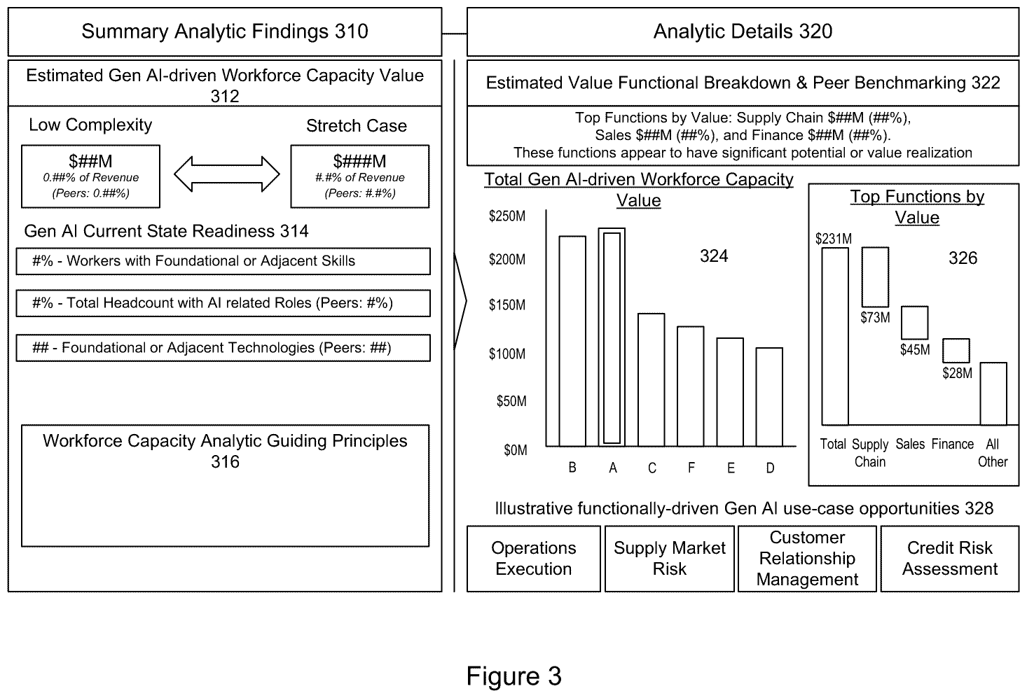

FIG. 3 is an exemplary user interface, according to an embodiment of the present invention. An embodiment of the present invention provides a summary of analytic findings that may be used to realize workforce capacity value. As shown in FIG. 3, Summary Analytic Findings 310 and Analytic Details 320 may be provided.

Summary Analytic Findings 310 may provide an Estimated Gen AI-driven Workforce Capacity Value at 312. Value may be shown as a range from Low Complexity to Stretch Case. Other variations in detail and ranges may be provided.

Gen AI Current State Readiness may be shown at 314. Readiness may be valued by workers with foundational or adjacent skills; total headcount with AI related roles (as compared to peers); and foundational or adjacent technologies (as compared to peers).

Workforce Capacity Analytic Guiding Principles may be shown at 316. This may provide details relating to estimated and directional outside-in view of an organization's workforce capacity potential value using a proprietary methodology in concert with third-party data. Gen AI-driven workforce capacity value enables leaders to determine how to allocate capacity created from Gen AI. In addition, a directional view into people and technology may facilitate the Gen-AI adoption journey.

Analytic Details 320 may provide an Estimated Value Functional Breakdown and Peer Benchmarking at 322. Graphic 324 may illustrate total Gen AI-driven workforce capacity value with top functions by value, e.g., supply chain, sales, finance and other. Top functions by value may include Supply Chain at 32%, Sales at 19% and Finance at 12% where these functions appear to have significant potential for value realization, as shown by 326. Other illustrations, graphics and level of granularity may be used.

Additional details may include supply chain use-case opportunities such as: Operations Execution, Supply Market Risk, etc. For Operations Execution use case, Gen AI may simplify work instructions into more understandable terms, break down complex processes into easy-to-follow steps, and provide real-time assistance to employees by answering questions, offering suggestions, and guiding them through complex tasks. For Supply Market Risk, Gen AI may help identify risks to the supply of key materials and inputs needed in operations. It may also provide recommendations to improve market risk monitoring procedures and practices.

Sales use case opportunities may include: customer relationship management; and customer sentiment analysis. For Customer Relationship Management, Gen AI may significantly improve and streamline CRM activities through more tailored customer interactions by analyzing customer feedback for sentiment, behavioral trends, and areas of improvement, leading to greater customer engagement and satisfaction. For Customer Sentiment Analysis, synthetic data may be generated to analyze customer feedback and sentiment, allowing retailers to improve product offerings and customer experience.

Finance use-case opportunities may include: credit risk assessment and general ledger maintenance. For Credit Risk Assessment, large language models may be used to analyze customer data and provide real-time credit risk assessments, enabling businesses to make more informed decisions about credit and reduce their exposure to risk. For General Ledger Maintenance, Gen AI models may automatically maintain the general ledger and automate repetitive tasks such as recording transactions, journal entries, account reconciliations, and validating invoices, helping to reduce errors and saving time for finance teams.

Illustrative functionally-driven Gen AI use case opportunities may be shown at 328 as Operations Execution; Supply Market Risk, Customer Relationship Management and Credit Risk Assessment. Other use case opportunities may be provided based on the entity, industry as well as other factors and considerations.

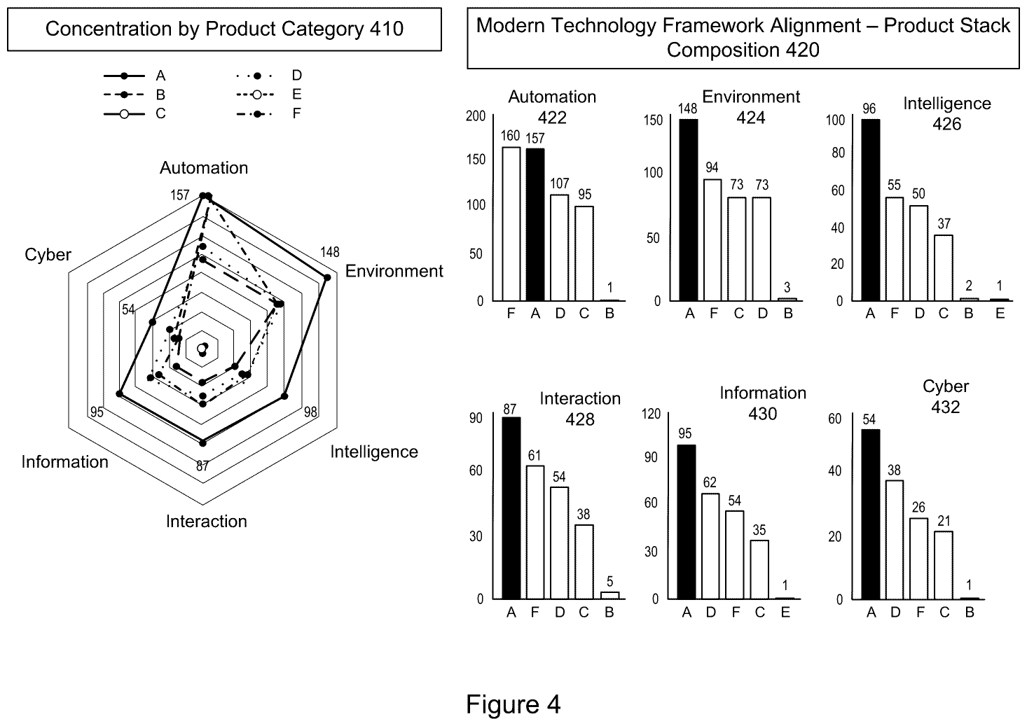

FIG. 4 is an exemplary user interface, according to an embodiment of the present invention. In this example, FIG. 4 illustrates technology readiness which may be demonstrated by Concentration by Product Category at 410 and Modern Technology Framework Alignment by Product Stack Composition at 420.

Concentration by Product Category 410 illustrates product category concentration for each entity, represented by A-F. In this example, product categories include: Automation, Environment, Intelligence, Interaction, Information and Cyber. Other product categories may be applied based on entity, industry and/or other factors and considerations. In addition, other graphics and illustrations may be implemented.

Modern Technology Framework Alignment 420 provides details for each product category on an entity basis. In this example, entities may represent peer corporations identified as A, B, C, D, E, and F.

FIG. 4 illustrates how Entity A ranks in terms of categories identified as Automation 422, Environment 424, Intelligence 426, Interaction 428, Information 430, and Cyber 432. This particular Entity A ranks first in the five categories of the Modern Technology Framework except it ranks second in Automation (as shown by 422).

In this example, 25% of the entity's product landscape is under Automation with 10 products having a Gen AI orientation.

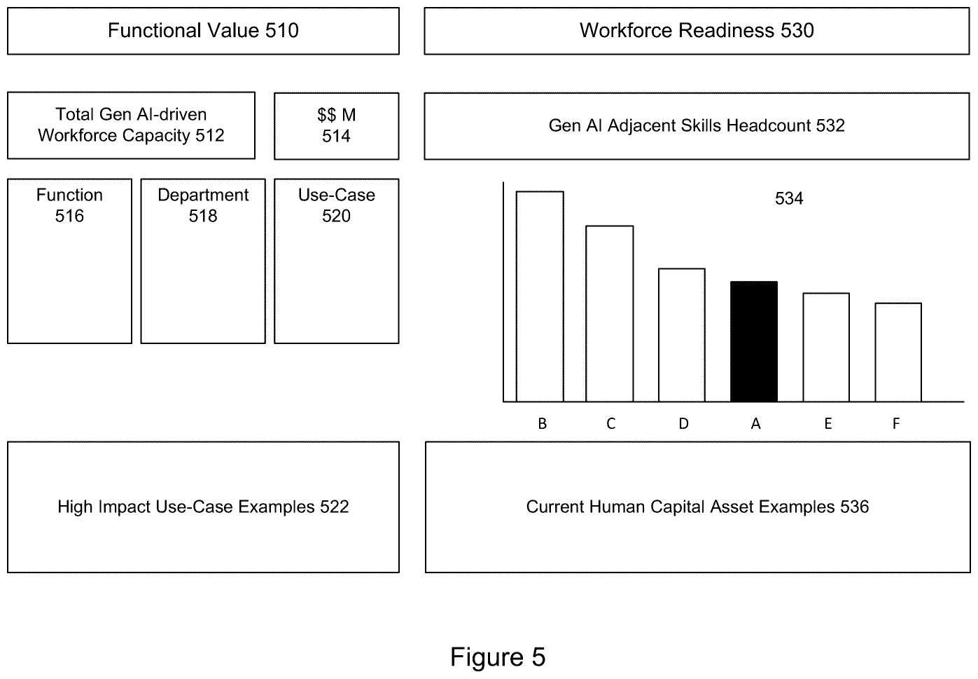

FIG. 5 is an exemplary user interface, according to an embodiment of the present invention. FIG. 5 illustrates priority Gen AI functional value and readiness. This may relate to Supply Chain, Sales and Finance. Functional Value 510 may include: Total Gen AI-driven Workforce Capacity 512 and Amount 514. Additional details may relate to: Function 516, Department 518 and Use-Case 520. High Impact Use Case examples may be provided at 522.

Workforce Readiness 530 may include a graphical representation 534 of Gen AI adjacent skills headcount relative to peers, at 532. Current Human Capital Asset Examples may be shown at 536.

For Supply Chain, an Entity's Supply Chain function may present an amount in potential Gen AI-driven workforce capacity value. Entity A may be able to leverage Gen AI to identify supply market risks and provide recommendations to enhance market risk monitoring procedures and streamlining operations execution, by translating complex instructions into more simple terms and providing real-time support to employees. Entity A may ascertain how it ranks in Gen AI adjacent skilled personnel relative to peers. In this example, Function 516 may include Supply Chain; Department 518 may include: manufacturing function and supply chain; and Use-Case 520 may include: Operations Execution and Supply Market Risk. High Impact Use-Case Examples 522 may highlight specific Gen AI impact on Operations Execution (Gen AI simplifies instructions, breaks down complex tasks and provides real-time help) and Supply Market Risk (Gen AI helps identify risks to the supply of key materials and inputs needed in operations; provides recommendations to improve market risk monitoring procedures and practices). Current Human Capital Asset Examples 536 may detail Roles/Skills (e.g., continuous improvement manager: a professional who designs, develops, and optimizes manufacturing processes, ensuring production, quality control, and continuous improvement in various industries).

For Sales, an Entity's Sales function may present an amount in potential Gen AI-driven workforce capacity value. Entity A may be able to leverage Gen AI to enhance CRM by analyzing customer feedback, identifying trends, and tailoring interactions for increased engagement, as well as to improve product offerings and customer experience through synthetic data-driven sentiment analysis. Entity A may ascertain how it ranks in Gen AI adjacent skilled personnel relative to peers. In this example, Function 516 may include Sales; Department 518 may include: Sales; and Use-Case 520 may include: Customer Relationship Management and Customer Sentiment Analysis. High Impact Use-Case Examples 522 may highlight specific Gen AI impact on Customer Relationship Management (Gen AI tailors customer interactions by analyzing feedback for sentiment and trends; improving CRM activities and boosting engagement and satisfaction) and Customer Sentiment Analysis (generate synthetic data to analyze customer feedback and sentiment, allowing retailers to improve product offerings and customer experience). Current Human Capital Asset Examples 536 may detail Roles/Skills (e.g., account manager: a professional tasked with maintaining client relationships, ensuring customer satisfaction, managing projects, identifying new opportunities, and overseeing account activities).

For Finance, an Entity's Finance function may present an amount in potential Gen AI-driven workforce capacity value. Entity A may be able to leverage Gen AI to refine cash flow forecasts, optimize working capital, aid investment decisions, identify financial risks, and automate general ledger maintenance to reduce errors and save time. Entity A may ascertain how it ranks in Gen AI adjacent skilled personnel relative to peers. In this example, Function 516 may include Finance; Department 518 may include: Global Business Services/Finance Operations; GL Accounting; and Use-Case 520 may include: Credit Risk Assessment and General Ledger Maintenance. High Impact Use-Case Examples 522 may highlight specific Gen AI impact on Credit Risk Assessment (large language models analyze customer data and provide real-time credit risk assessments, enabling businesses to make more informed decisions about credit and reduce their exposure to risk) and General Ledger Maintenance (Gen AI automates general ledger tasks, reducing errors and saving time by recording transactions, journal entries, reconciling accounts and validating invoices for finance teams). Current Human Capital Asset Examples 536 may detail Roles/Skills (e.g., credit manager: a professional that analyzes customer data and provide real-time credit risk assessments).

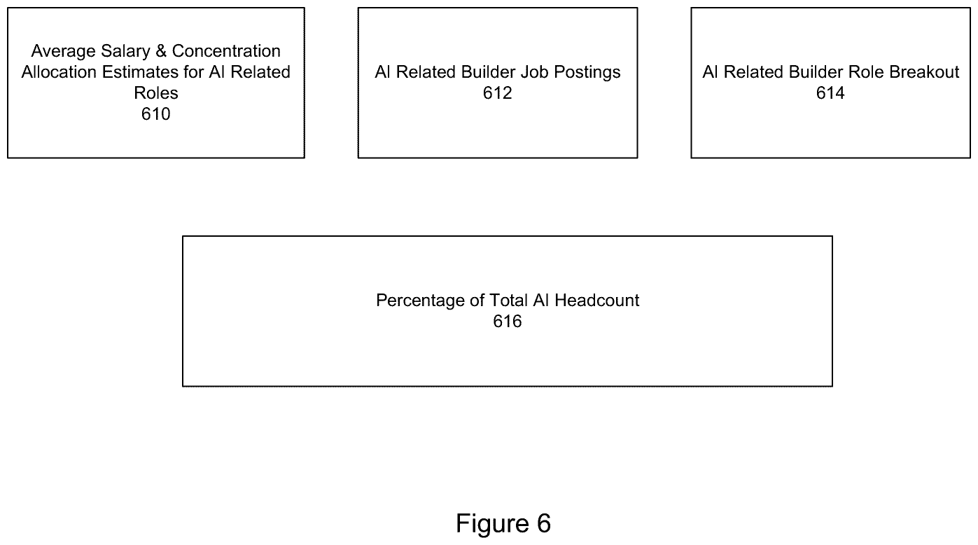

FIG. 6 is an exemplary user interface, according to an embodiment of the present invention. FIG. 6 illustrates Headcount Ratio and Allocation of AI related roles. Average Salary and Concentration of Allocation Estimates for AI Related Roles may be shown at 610. This may involve an average salary for specific roles (e.g., application engineer, data analyst, infrastructure engineer, IT project manager, IT specialist, software engineer, etc.) and a comparison with peer entities. AI Related Builder Job Postings 612 may graphically illustrate job postings percentages on a yearly or other basis. AI related Builder Role Breakout 614 may illustrate roles for each entity. Roles may include application engineer, data analyst, infrastructure engineer, IT project manager, IT specialist, software engineer, etc. Percentage of Total AI Headcount 616 may provide detailed information for each entity and headcount percentages for specific roles. In this example with regards to Gen AI related roles, an entity may demonstrate a lower percent of headcount and higher salaries, which may be a negative contributor to the Gen AI roadmap.

Gen AI offers an opportunity to automate and augment previously challenging worker tasks that span across the enterprise. This application of technology may create financial and organizational value, helping build a case for investment and transformational pull-through. As a result, an embodiment of the present invention is directed to a human-centered approach to Gen AI-driven transformation.

An embodiment of the present invention is directed to a Gen AI-driven workforce transformation approach that provides outside-in insights that estimate workforce potential value with third party data for preliminary discussions as well as insights into people and technology accelerating Gen AI approach.

An embodiment of the present invention is directed to Gen AI workforce opportunity assessment and roadmap development process. This may involve using client data to identify, quantify and prioritize role augmentation activities and tasks; aligning deconstructed work with Gen AI solutions and data requirements; and clarifying role impacts for adoption enablement plans.

Data assessment may involve: analyzing client workforce data to validate productivity and capacity opportunities using the Value Assessment Toolset; normalizing worker roles through standardization of jobs, activities, and skills taxonomy; prioritizing the Gen AI role augmentation opportunities based on cost of service, volume, risk, brand, and culture considerations; defining Gen AI use cases to prioritized roles and enterprise functions; validating client technology landscape to determine additional requirements; and delivering Gen AI roadmap, key enablers and quantification of opportunity value, incremental technology costs to establish data-drive business case.

Client outcomes may include: value opportunity summary by enterprise function and role; Gen AI technology and use case roadmap; and workforce capacity, productivity, and efficiency focused assessment and roadmap depending on organization size and global dimensions. Additional value levers incremental.

An embodiment of the present invention is directed to Gen AI-driven workforce capacity peer benchmarking. Organizations with a significant presence of both skilled professionals (e.g. Supply Chain, Sales, Finance, etc.) and technology applications/spend generally have greater Gen AI workforce capacity. Analytics may involve: total Gen AI-drive workforce capacity value and functional Gen AI-drive workforce capacity opportunity (e.g., cyber, finance, other front office, HR, IT, marketing, risk, sales, services and data analytics and supply chain).

An embodiment of the present invention is directed to Gen AI current state investments and quantitative peer benchmarking. The data suggests that among peers there is a higher investment concentration in enabled technology than in knowledge workers with Gen AI foundational skills. Analytics may involve: total current investments in Gen AI-adjacent skills and technologies and total Gen AI-adjacent investments by function (e.g., cyber, finance, other front office, HR, IT, marketing, risk, sales, services and data analytics and supply chain).

An embodiment of the present invention is directed to cross-functional use-case profiling and prioritization. The Supply Chain, Sales, and Finance functions have been identified as key areas with the highest potential for generating value from Gen AI. Analytics may include: total use-cases and use-case prioritization and Gen AI-driven workforce capacity value by function (e.g., supply chain, sales, finance, other front office, IT, services and data analytics, HR, marketing, cyber, risk).

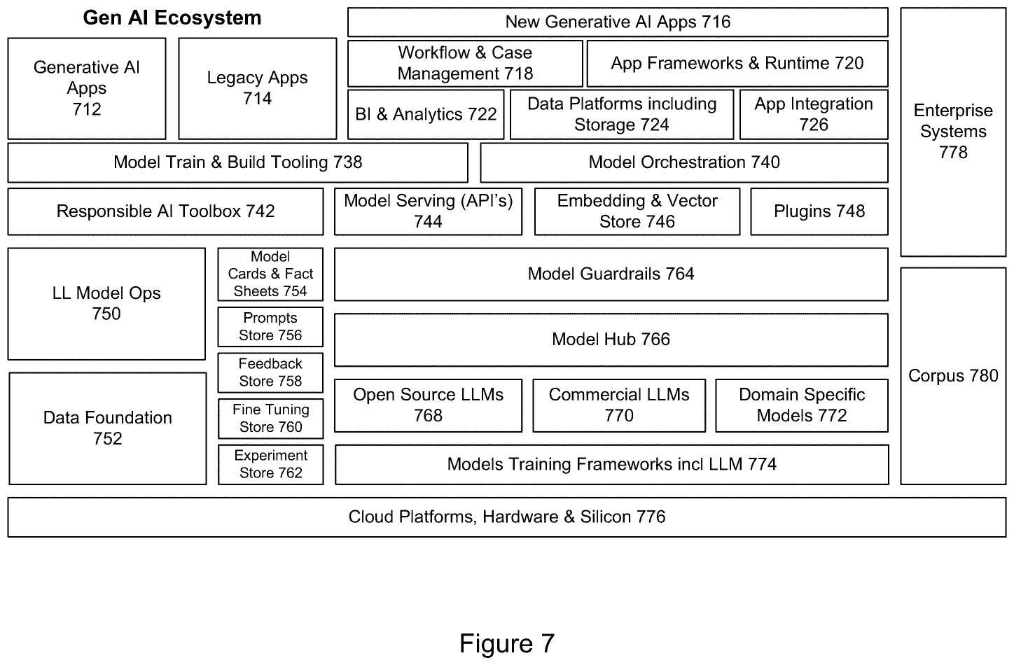

FIG. 7 is an exemplary diagram, according to an embodiment of the present invention. FIG. 7 illustrates an exemplary Gen AI ecosystem.

Existing Technology may include: Generative AI Apps 712; Legacy Apps 714; Workflow and Case Management 718; App Frameworks and Runtime 720; BI and Analytics 722; Data Platforms including Storage 724; and App Integration 726.

Models may be integrated through: Model Hub 766; Open Source LLMs 768; Commercial LLMs 770, Domain Specific Models 772.

Enablers may include: Model Train & Build Tooling 738; Model Orchestration 740; Model Serving (APIs) 744; Embedding and Vector Store 746; Plugins 748; LL Models Ops 750; Data Foundation 752; Prompts Store 756; Feedback Store 758; Fine Tuning Store 760 and Experiment Store 762. LL Models Ops may include: Model Evaluation; Error Analysis; Fairness Analysis; Model Deployment; Model Metadata Management; Experiment Tracking; Counterfactual Analysis; Hallucination Analysis; and Model Monitoring. Data Foundation 752 may include: Ingestion and Cleansing; Data Labeling; Prompt Design; and Human Review.

Control Features may include: Responsible AI Toolbox 742; Model Cards and Fact Sheets 754; Model Guardrails 764.

Gen AI apps may include: New Generative AI Apps 716.

Other features may include: Enterprise Systems 778; Corpus 780; Models Training Frameworks 774; and Cloud Platforms, Hardware and Silicon 776.

An embodiment of the present invention may assess a target company's current technology stack, e.g., what large language models are in use, engineering pipeline, technology spend, technology team details, etc.

An embodiment of the present invention may also assess risk, security, vulnerabilities, costs and/or other factors associated with Gen AI opportunities. For example, investing in and implementing Gen AI in a particular sub-division within the target company may result in potential security issues and risks. An embodiment of the present invention may identify mitigation responses to address potential risks.

An embodiment of the present invention may identify other associated opportunities, such as tax benefit or an improved tax circumstance by introducing Gen AI. Examples may include obtaining a tax credit for R&D and identifying resources and/or employees for additional R&D projects.

An embodiment of the present invention may map target entity data from third party and/or other sources to a taxonomy to assess Gen AI opportunities. An embodiment of the present invention may integrate target entity data to generate fine-tuned more accurate and relevant insights. For example, client data may be more granular, specific and relevant than data from third party sources. Client data may reveal additional insights, e.g., what tasks/projects/opportunities do analysts spend their time. Additional insights may be obtained relating to changes in roles, services, functions, offerings, etc. For example, a target company may automate more tasks in certain areas and teams where specific details (e.g., number of employees, task features, etc.) may be available through client data. A mix of data sources (e.g., client data, third party data, industry data, forecasting data, AI generated data, etc.) may also be applied. Other variations and adjustments may be applied.

An embodiment of the present invention may support a self-refinement capability that may evolve as the system reiterates and learns from prior opportunities and associated results/outcomes/learnings.

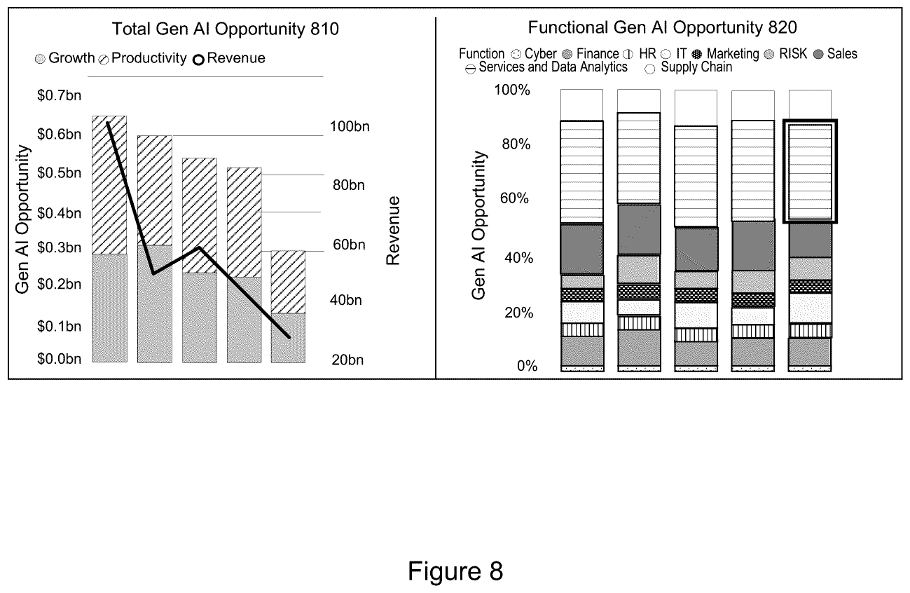

FIG. 8 illustrates Generative AI Opportunity Peer Benchmarking, according to an embodiment of the present invention. FIG. 8 illustrates a Total Gen AI Opportunity 810 and a Functional Gen AI Opportunity 820. As shown in FIG. 8, this peer group holds high opportunity value across various functional domains. The most significant opportunities are within services and data analytics, sales and supply chain functions. Of those, service & data analysis presents the most substantial investment opportunities.

Organizations with high headcount and strategic investments in technology may have greater Gen AI opportunity. An entity may have both the smallest total Gen AI-adjacent opportunity and total revenue within the peer group.

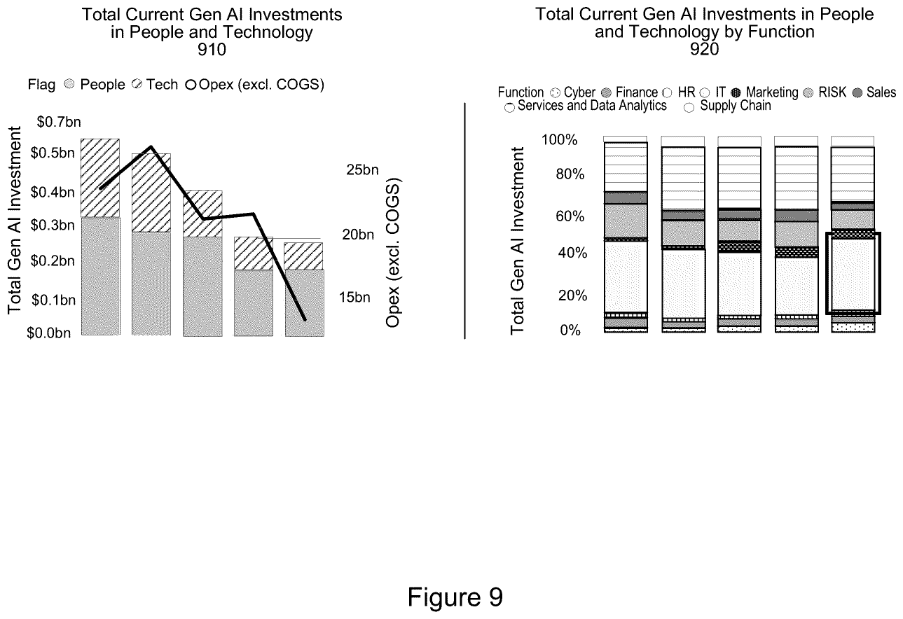

FIG. 9 illustrates Generative AI Current State Investments & Peer Benchmarking, according to an embodiment of the present invention. FIG. 9 illustrates Total Current Gen AI

Investments in People and Technology 910 and Total Current Gen AI Investments in People and Technology by Functions 920. As shown in FIG. 9, this peer group prioritizes investment in skilled personnel for Gen AI enablement rather than technology readiness. This entity invests significantly in skilled people than their peers, while another entity ranks last when it comes to investing in Gen AI enabling technology and skilled personnel across functions. This group of industry peers is focusing on a range of functions for their Gen AI adjacent investments. IT, risk, and services and data analytics are currently the most valuable functions. This entity is similar to peers in allocating most of their current investment in the IT and Services functions.

An embodiment of the present invention may also consider additional workflows related to the Gen AI Opportunities. For example, as investments are made in certain functions that provide faster and more accurate outputs, other parts of the organization may need to respond accordingly to leverage and further propagate the Gen AI Opportunities, whether directly related or somehow affected. Other parts of the target company may need to adjust accordingly.

An embodiment of the present invention is directed to identifying Gen AI Opportunities, including Corporate Listening and Industry Intelligence; Technology Stack Alignment Review; and Organizational Skill and People Readiness Assessment. Technology Stack Alignment may refer to a company's investment, usage, and adoption of technology components that enable use of Gen AI.

Gen AI Opportunities may include: cross-functional use-case profiling and prioritization; Gen AI functional value & readiness (e.g., S&D analysis; sales; supply chain); Gen AI technology current state quantitative assessment; and Gen AI rapid current state assessment outcomes.

Corporate Listening and Industry Intelligence may include: trends on executive perspectives on Gen AI; key industry (e.g., pharmaceutical) Gen AI trends; Gen AI adoption (e.g., Gen AI rapidly gains share of voice in AI conversations), etc.

Technology Stack Alignment Review may include: Gen AI adjacent technology current state benchmarking outcomes; Gen AI adjacent technology product breadth and utilization; Concentration on Gen AI adjacent product; Position regarding Gen AI adjacent infrastructure across organization functions; Utilization of Gen AI adjacent product; Adoption of Gen AI adjacent infrastructure level of experience; and Future Value (e.g., buying signals for Gen AI related technologies).

Organizational Skill and People Readiness Assessment may include: Gen AI current state people opportunity peer benchmarking; Gen AI people and skills current state benchmarking outcomes; upskilling leadership in digital literacy results in higher net income; many organizations don't have leaders with the needed digital capabilities; Readiness: AI literacy is concentrated at the junior level; Concentration: organizational and Gen AI human capital profiles; Concentration: Gen AI-related employee roles; Position: Gen AI adjacent skilled employees across organization functions; Future Value: Gen AI-related job postings, etc.

An embodiment of the present invention is directed to Client Data Collection Survey, which may include: Gen AI connected value chain; Gen AI capability maturity model; Gen AI rapid phases; organization transformation solution (OTS).

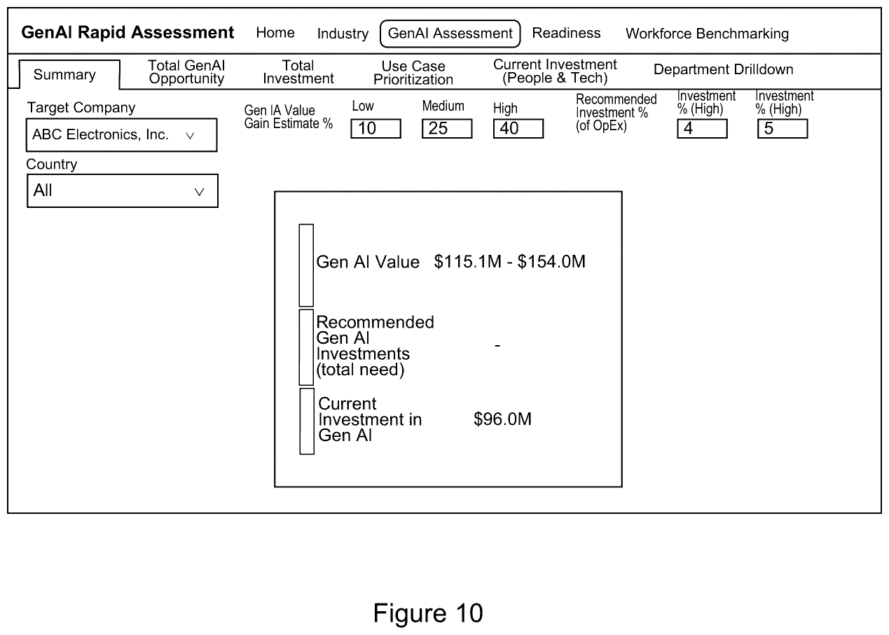

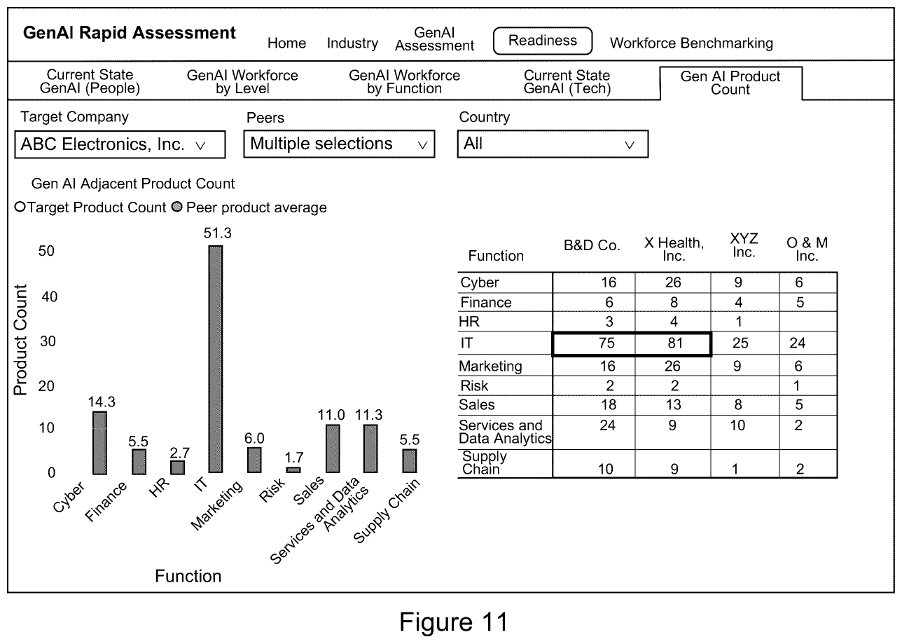

FIGS. 10-11 illustrate exemplary user interfaces, according to an embodiment of the present invention.

FIG. 10 illustrates a Gen AI Assessment interface with Gen AI value, Recommended Gen AI investments and Current Investment in Gen AI for a target company.

FIG. 11 illustrates a Gen AI Assessment interface with Gen AI Adjacent Product Count for a target company and peers. A graphic may include product count compared to functions.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications and equivalent arrangements.

The foregoing descriptions provide examples of different configurations and features of embodiments of the invention. While certain nomenclature and types of applications/hardware are described, other names and application/hardware usage is possible and the nomenclature is provided by way of non-limiting examples only. Further, while particular embodiments are described, it should be appreciated that the features and functions of each embodiment may be combined in any combination as is within the capability of one skilled in the art. The figures provide additional exemplary details regarding the various embodiments.

Various exemplary methods are provided by way of example herein. The methods described can be executed or otherwise performed by one or a combination of various systems and modules.

The use of the term computer system in the present disclosure can relate to a single computer or multiple computers. In various embodiments, the multiple computers can be networked. The networking can be any type of network, including, but not limited to, wired and wireless networks, a local-area network, a wide-area network, and the Internet.

According to exemplary embodiments, the system software may be implemented as one or more computer program products, for example, one or more modules of computer program instructions encoded on a computer-readable medium for execution by, or to control the operation of, data processing apparatus. The implementations can include single or distributed processing of algorithms. The computer-readable medium can be a machine-readable storage device, a machine-readable storage substrate, a memory device, or a combination of one or more of them. The term “processor” encompasses all apparatus, devices, and machines for processing data, including by way of example a programmable processor, a computer, or multiple processors or computers. The apparatus can include, in addition to hardware, software code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

A computer may encompass all apparatus, devices, and machines for processing data, including by way of example a programmable processor, a computer, or multiple processors or computers. It can include, in addition to hardware, code that creates an execution environment for the computer program in question, e.g., code that constitutes processor firmware, a protocol stack, a database management system, an operating system, or a combination of one or more of them.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computer-readable media suitable for storing computer program instructions and data can include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While the embodiments have been particularly shown and described within the framework for conducting analysis, it will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

What is claimed is:

1. A system for implementing a Generative AI Opportunity Assessment Tool comprising:
an input configured to access one or more data sources that store and manage workforce data for at least one target entity;
an interactive user interface that communicates with one or more user devices via a communication network; and
a computer processor coupled to the input, the interactive user interface and the one or more data sources, the computer processor further configured to:
identify a target entity and a set of peer entities;
generate a baseline assessment, by applying an assessment model, of a financial opportunity for the target entity in leveraging Generative AI at scale;
align organization role profiles of the target entity with a taxonomy that classifies work activities and processes;
applying a unique set of use cases, identify a set of organizational roles that illustrate Generative AI agents of change;
generate a productivity estimate at an activity level based on workforce data relevant to the target entity;
determine an impact comprising a number of workers and total salaries;
generate a Generative AI driven workforce capacity value defined by role and function and supplemented with relevant use-cases;
generate a current state assessment of existing technology and skills within the target entity relating to Generative AI wherein the current state assessment is based on third party workforce salary and skills data at a role level;
apply the assessment model to the target entity's workforce data to determine an appropriate change management relating to technology and workforce shaping; and identify a workforce capacity opportunity for the target entity.

2. The system of claim 1, wherein the workforce capacity opportunity comprises summary analytic findings and analytic details.

3. The system of claim 2, wherein the summary analytic findings comprises an estimated Generative AI driven workforce capacity value and a Generative AI current state readiness.

4. The system of claim 3, wherein the Generative AI current state readiness comprises workers with foundational or adjacent skills; total headcount with AI related roles; and foundational or adjacent technologies.

5. The system of claim 2, wherein the analytic details comprises an estimated value functional breakdown and peer benchmarking and a total Generative AI-driven workforce capacity value graphic.

6. The system of claim 5, wherein the total Generative AI-driven workforce capacity value graphic comprises top functions by value.

7. The system of claim 6, wherein the top functions by value comprise supply chain opportunities; sales opportunities; and finance opportunities.

8. The system of claim 1, wherein the workforce capacity opportunity comprises technology readiness that includes: concentration by product category and modern technology framework alignment graphic.

9. The system of claim 8, wherein the product category comprises: automation, environment, intelligence, interaction, information and cyber.

10. The system of claim 1, wherein the workforce capacity opportunity comprises a headcount ratio and an allocation of AI related roles.

11. A method for implementing a Generative AI Opportunity Assessment Tool comprising the steps of:
identifying a target entity and a set of peer entities;
generating a baseline assessment, by applying an assessment model, of a financial opportunity for the target entity in leveraging Generative AI at scale;
aligning organization role profiles of the target entity with a taxonomy that classifies work activities and processes;
applying a unique set of use cases, identifying a set of organizational roles that illustrate Generative AI agents of change;
generating a productivity estimate at an activity level based on workforce data relevant to the target entity;
determining an impact comprising a number of workers and total salaries;
generating a Generative AI driven workforce capacity value defined by role and function and supplemented with relevant use-cases;
generating a current state assessment of existing technology and skills within the target entity relating to Generative AI wherein the current state assessment is based on third party workforce salary and skills data at a role level;
applying the assessment model to the target entity's workforce data to determine an appropriate change management relating to technology and workforce shaping; and
identifying a workforce capacity opportunity for the target entity.

12. The method of claim 11, wherein the workforce capacity opportunity comprises summary analytic findings and analytic details.

13. The method of claim 12, wherein the summary analytic findings comprises an estimated Generative AI driven workforce capacity value and a Generative AI current state readiness.

14. The method of claim 13, wherein the Generative AI current state readiness comprises workers with foundational or adjacent skills; total headcount with AI related roles; and
foundational or adjacent technologies.

15. The method of claim 12, wherein the analytic details comprises an estimated value functional breakdown and peer benchmarking and a total Generative AI-driven workforce capacity value graphic.

16. The method of claim 15, wherein the total Generative AI-driven workforce capacity value graphic comprises top functions by value.

17. The method of claim 16, wherein the top functions by value comprise supply chain opportunities; sales opportunities; and finance opportunities.

18. The method of claim 11, wherein the workforce capacity opportunity comprises technology readiness that includes: concentration by product category and modern technology framework alignment graphic.

19. The method of claim 18, wherein the product category comprises: automation, environment, intelligence, interaction, information and cyber.

20. The method of claim 11, wherein the workforce capacity opportunity comprises a headcount ratio and an allocation of AI related roles.
